(19) United States
(12) Patent Application Publication
(10) Pub. No.: US 2003/0140937 A1
(43) Pub. Date: Jul. 31, 2003

(54) Dental floss device

(76) Inventor: Christopher Cook, Bakersfield, CA (US)

Correspondence Address: Dennis W. Beech, LAW OFFICES OF DENNIS W. BEECH, Suite C-2, 19900 Beach Blvd., Huntington, CA, 92648, US

(21) Appl. No.: 10/058,910

(22) Filed: Jan. 30, 2002

(51) Int. Cl. A61C 15/00

(52) U.S. Cl. 132/323

(57) ABSTRACT

A dental floss device having an applicator with a handle attached. The applicator may be formed in the shape of a curved trough to allow placing the applicator over the teeth of a person's upper or lower jaw. Dental floss is attached to each upper rim of the side walls of the applicator in positions to be pushed between the teeth for purposes of flossing. The applicator may be used to floss all of the teeth of an upper or lower jaw in a simultaneous application. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### BACKGROUND OF THE INVENTION

This invention relates to devices designed to hold dental floss for use in cleaning teeth. The new device uses an applicator structure to hold multiple strands of dental floss to allow cleaning of a plurality of gaps between a persons teeth in a simultaneous manner.

The use of dental floss for cleaning teeth and the gaps therebetween is well known in the art. There are also known various devices for holding or retaining dental floss strands that usually have a handle portion. An example of such devices is disclosed in U.S. Pat. No. 5,692,531 wherein one or two strands of dental floss are attached between the ends of arms attached to a handle. These type devices are designed to clean between teeth one gap at a time. The two strand version is structured to provide back-up of one strand to the other or for alternating use of strand elements. There is no provision for simultaneously cleaning of multiple gaps between teeth.

There are variations of devices for flossing of teeth that allow insertion of floss strands around teeth for cleaning the gap on each side of a tooth. These devices may also include a single loop of floss attached in a manner to place a floss strand around a tooth for cleaning three surfaces thereof. The loop of floss when moved up and down on a tooth cleans the back side and two edges of the tooth. While this operation may simultaneously clean two gaps between teeth, there is no consideration or anticipated method for cleaning more than two gaps in one cleaning application.

As can be seen, there is a need for a dental floss device that may be used to clean a plurality of gaps between a persons teeth in a simultaneous manner.

### SUMMARY OF THE INVENTION

The present invention is directed to devices for retaining dental floss for flossing of teeth. An applicator may have a handle attached thereto with the applicator having dental floss elements retained and positioned for insertability between the teeth of a user in the gaps therebetween.

These and other features, aspects and advantages of the present invention will become better understood with reference to the following drawings, description and claims.

### BRIEF DESCRIPTION OF THE DRAWINGS

FIG. 1 illustrates a front perspective view of a persons upper teeth and the dental floss device positioned for use according to an embodiment of the invention;

FIG. 2 illustrates a top plan view according to an embodiment of the invention;

FIG. 3 illustrates a side cross sectional elevation view according to an embodiment of the invention;

FIG. 4 illustrates a top plan view according to an embodiment of the invention;

FIG. 5 illustrates a side cross sectional elevation view according to an embodiment of the invention.

### DESCRIPTION OF THE PREFERRED EMBODIMENT

The following detailed description is the best currently contemplated modes for carrying out the invention. The description is not to be taken in a limiting sense, but is made merely for the purpose of illustrating the general principles of the invention.

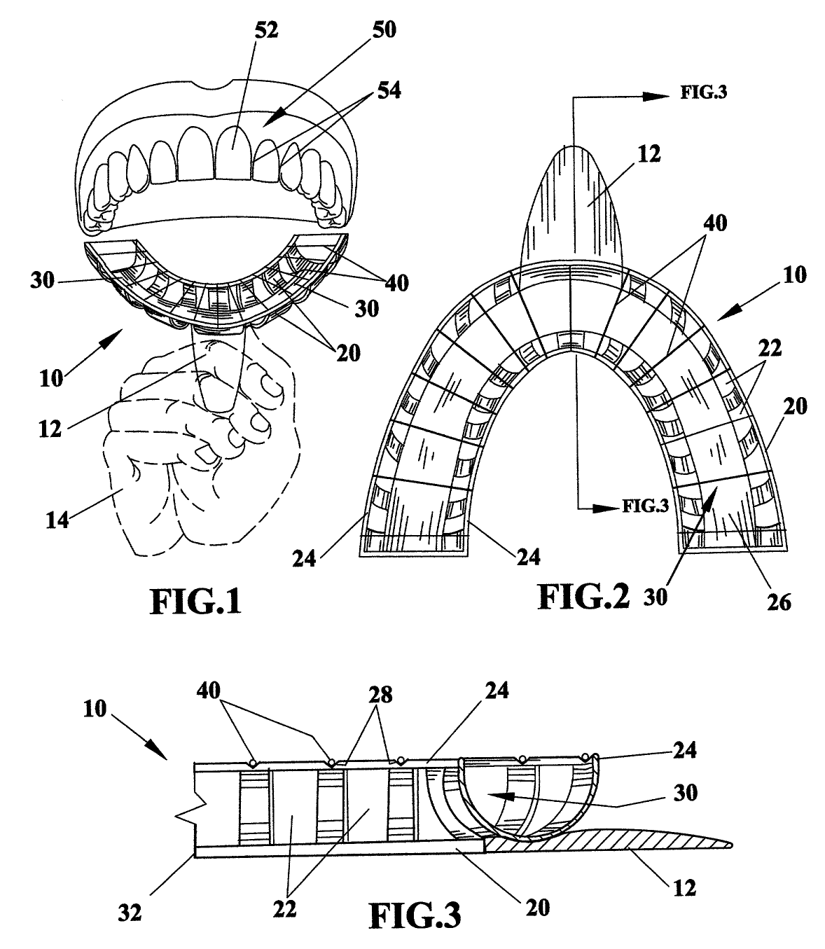

Referring to FIG. 1, a dental floss device 10 may have an applicator 20 and a handle 12. The handle 12 may be grasped by a user's hand 14 to facilitate placing the applicator in the month along a row of teeth 50 to align strands of dental floss 40 for purposes of cleaning the gaps 54 between the teeth 52. The user may then use the handle 12 to push the applicator 20 and thereby the dental floss 40 between the teeth 52 to clean the gaps 54 and sides of the teeth 52. Use of an up and down motion of the dental floss device 10 may simultaneously clean the gaps 54 on a person's upper or lower jaw.

Referring to FIGS. 2 and 3, the applicator 20 may be a generally curved, trough shaped structure for placing over the upper or lower teeth of a person. The applicator 20 may have curved side wall bands 21 with an upper rim 24 and a support base 26 forming a curved groove 30. The side wall bands 21 may have voids 22 therebetween and may be of other shapes such as straight side walls 22 as well as other form factors that fit in a user's mouth and allow motion of the dental floss 40 between the teeth 52. The handle 12 may be attached to facilitate inserting the applicator in the mouth and shaped for ease in flossing the teeth 52.

The rim 24 of the applicator 20 may have slots 28 into which dental floss 40 may be inserted and retained. The slots 28 may be designed to permanently retain strands of dental floss 40 in which instance the dental floss device 10 may be disposable after each use. The dental floss 40 may be molded into the rim 24 at the time of manufacture of the device 10.

The slots 28 may also provide position locations for the user to place bands of dental floss 40. In this application the user may place bands of dental floss sized to the structure of the applicator 20 into opposing slots 28 at the locations thereof on the rim 24. The slots 28 may also be used wherein a continuous strand of dental floss 40 is wrapped around the applicator 20. The dental floss 40 may be wrapped around the side wall bands 21 outer surface and voids 22 and placed in opposing slots 28 at each rim 24 position. The ends of the dental floss 40 may be attached to the applicator by a fastener or an adhesive.

The structure of the applicator 20 and location of the dental floss 40 may be constructed in various sizes based on the mouth and jaw characteristics of users. The applicator 20 may be shaped to fit a variety of user teeth configurations by structuring a wide tolerance groove 30 and allowing flexibility of lateral motion of the dental floss 40 relative to dental floss 40 locations in the rim 24. Thereby, variations in tooth spacing within a general human jaw pattern and size may be accommodated by a range of standard dental floss devices 10 for segments of the population. This may preclude the need for individual sized dental floss devices 10. While slots 28 have been used to describe an embodiment, other forms may be used as for example apertures (not shown) may be formed in the rim 24 through which dental floss 40 may be threaded and retained, and the dental floss 40 may be molded into the rim 24 at the time of manufacture of the device 10.

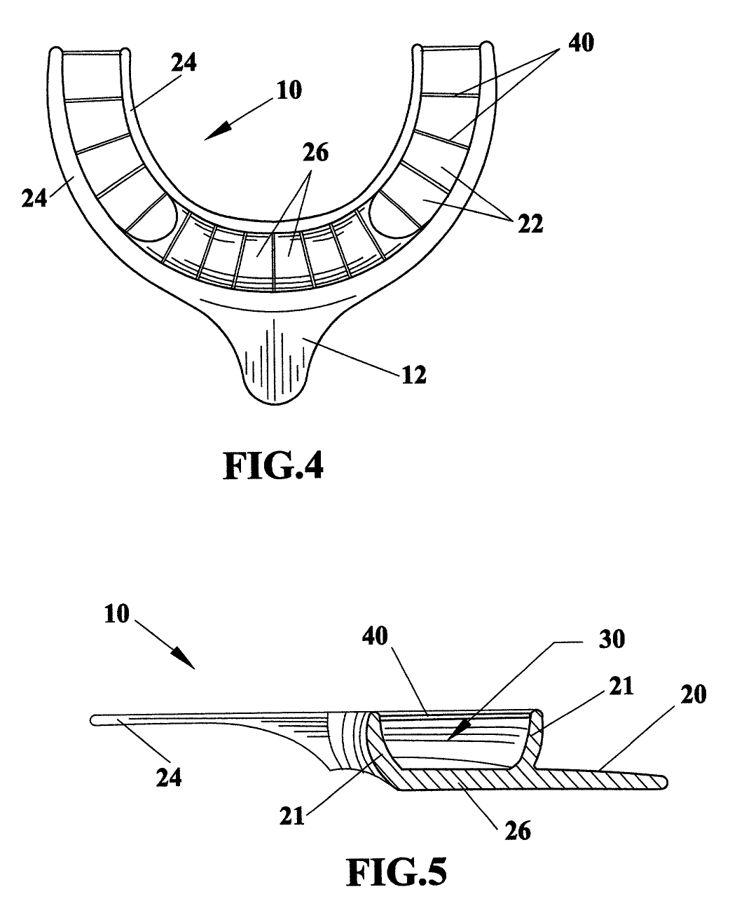

Referring to FIGS. 4 and 5, the dental floss device may have a truncated trough 30 formed by support base 26 and sidewalls 21. The rim 24 elements may extend to retain the dental floss 40 for use in cleaning the gaps between the teeth.

While the invention has been particularly shown and described with respect to the illustrated and preferred embodiments thereof, it will be understood by those skilled in the art that the foregoing and other changes in form and details may be made therein without departing from the spirit and scope of the invention.

I claim:

1. A device for retaining dental floss for flossing of teeth comprising:
an applicator having a handle attached thereto; and
said applicator having a plurality of dental floss elements retained and positioned for insertability between a plurality of teeth having gaps therebetween.

2. The device as in claim 1 wherein said applicator comprising a pair of side walls each having a rim and joined at a support base.

3. The device as in claim 2 wherein each rim having a plurality of slots formed therein for positioning and retaining said dental floss elements.

4. The device as in claim 2 wherein each rim having a plurality of apertures formed therein for positioning and retaining said dental floss elements.

5. The device as in claim 2 wherein said dental floss elements are retained and positioned by molding of said dental floss elements in each rim.

6. The device as in claim 1 wherein said dental floss elements are a plurality of dental floss bands.

7. The device as in claim 2 wherein said dental floss elements are portions of a single strand of dental floss.

8. The device as in claim 2 wherein said pair of sidewalls having voids therein to facilitate positioning of said dental floss elements for flossing of teeth.

9. The device as in claim 2 wherein said pair of sidewalls and said support base are truncated with said rims extending therefrom.

10. A device for retaining dental floss for flossing of teeth comprising:
an applicator comprising a pair of side walls joined at a bottom end and each side wall having a rim;
a handle attached to said applicator; and
a plurality of dental floss elements retained and positioned for insertability between a plurality of teeth having gaps therebetween.

11. The device as in claim 10 wherein each rim having a plurality of slots formed therein for positioning and retaining said dental floss elements.

12. The device as in claim 10 wherein each rim having a plurality of apertures formed therein for positioning and retaining said dental floss elements.

13. The device as in claim 10 wherein said dental floss elements are retained and positioned by molding of said dental floss elements in each rim.

14. The device as in claim 10 wherein said pair of side walls having voids therein to facilitate positioning of said dental floss elements for flossing of teeth.

15. The device as in claim 10 wherein said pair of sidewalls and said support base are truncated with said rims extending therefrom.

16. A device for retaining dental floss for flossing of teeth comprising:
an applicator comprising a pair of side walls joined at a bottom end and each side wall having a rim; and
a plurality of positioning and retaining elements formed in said rim located for receipt of a plurality of dental floss elements for insertability around all of the teeth of one of the upper jaw and lower jaw of a person.
